(19) United States
(12) Patent Application Publication
(10) Pub. No.: US 2005/0154923 A1
(43) Pub. Date: Jul. 14, 2005

(54) SINGLE USE SECURE TOKEN APPLIANCE

(76) Inventors: Simon Lok, Vero Beach, FL (US); Stuart Woodward, Vero Beach, FL (US); Peter Knezevich, Vero Beach, FL (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/905,542

(22) Filed: Jan. 10, 2005

Related U.S. Application Data
(60) Provisional application No. 60/481,877, filed on Jan. 9, 2004.

(51) Int. Cl. H04L 9/32; G06F 12/14

(52) U.S. Cl. 713/202; 713/185

(57) ABSTRACT

Systems, methods, software and data structures that facilitate the trusted, secure data exchange of data over networks, including open networks such as the Internet.

### RELATED APPLICATIONS

The present invention claims the benefit of U.S. Provisional Patent Application Ser. No. 60/481,877 filed on Jan. 9, 2004, which is incorporated herein by reference.

### FIELD OF THE INVENTION

The present invention relates, in general, to trusted computing, and, more particularly, to systems, methods, software and data structures that facilitate the trusted, secure data exchange of data over networks, including open networks such as the Internet.

### RELEVANT BACKGROUND

Information and information exchange play an increasingly important role in the worldwide economy. Digital communication, i.e., the exchange of information using digital formats, represents and increasingly prevalent mode of human communication. This involves machine-to-machine, machine-to-human, and human-to-human communication. Digital communication lacks the natural mechanisms of face-to-face communication in that it is more difficult to ensure confidentiality of the communication. Moreover, because participants may be separated by great physical distances or other barriers, it is difficult to authenticate participants, ensure the integrity of messages, and to provide against repudiation of a received communication.

Exchanged information can be protected by cryptography. Cryptography involves processes that alter message content by transformation into another form which is understandable only by the intended recipient or recipients of the message. Currently, cryptography may be performed by encoding the original message into an incomprehensible protected message according to mathematical algorithms using a particular key. Only the correct recipient(s) should have both the same algorithm and the particular key needed to decode the protected message into the original message. Thus, the incomprehensible encoded message can be freely transmitted over a relatively insecure communication channel while remaining secure to all but the correct recipient(s).

Two groups around the world—governments and their citizens—are pushing improvements in security for information transmitted over private and public networks such as the Internet. In response to public demand, the United States, Congress, together with various governmental and regulatory agencies, has enacted new laws. Concern over the disclosure of personal information over the Internet led to the Gramm-Leach-Bliley Act concerning financial institutions and to the Healthcare Insurance Portability and Accountability Act (HIPAA) concerning the healthcare industry. The requirements of this legislation are considerable and compliance with these requirements places a significant burden on businesses and individuals charged with managing business communications.

In Europe individual governments are passing resolutions and setting standards to secure personal and corporate information as it travels over the Internet. On a broader scale, the European Union (“EU”) Parliament resolved: “E-mails can and should be encrypted by everyone”. It then urged public authorities to set a good example by employing encryption as a standard practice in order to demystify the process and establish a standard. Furthermore, the EU Data Protection Act establishes the confidential nature of all information—including names and addresses. Penalties under the Act are comparatively more severe and significant than under the United States laws.

Information privacy is only one concern—data integrity is also of increasing importance. Data integrity refers generally to assuring that data has not been intentionally or inadvertently altered during creation, storage and transmissions. The only way to ensure the integrity and security of information is through cryptographic means. There are many ways that data can become corrupted either intentionally or accidentally. Using cryptographic techniques, it is possible to detect when even a single bit of information has been altered.

Systems for providing security and data integrity tend to be implemented in a manner that allows pre-defined entities (e.g., people, groups of people, software programs and the like) to have specified permissions with respect to accessing and modifying data. A typical way in which this model is implemented uses digital certificates (e.g., public key pairs) that are assigned to the various entities, and data processing systems constrain data access based on permissions associated with the certificates. This security model is targeted to environments where the entities and their permissions are relatively persistent or slow changing. For example, giving each employee a specified set of permissions with respect to an organization's data is manageable because the population of employees changes relatively slowly. When the entities change rapidly, the time and expense of certification and system updates are significant.

U.S. Pat. No. 6,445,794 to Shefi describes a method for generating an identical electronic one-time pad at a first location and a second location. The Shefi method involves providing a table of true random numbers stored on non-volatile memory at the first and second location where the table is identical at both locations. A software program at each location obtains a true random number from the table and uses the selected true random number to form an identical electronic one-time pad at the first and the second locations. The Shefi system, however, does not address transient access to the one time pads, and instead is concerned with providing a system that secures communication between fixed location machines, or at least machines that are recognized by the system and specially configured to use the one time pad information.

However, there is an increasing need to manage transient access to information. Transient access refers to environments where an entity may be allowed a single access (or limited number of accesses) to an organization's information. In such environments it may be desirable to establish the credentials and permissions on an as-needed basis. However, existing security management systems make setting up these ad-hoc relationships difficult.

A need exists for systems, methods, software and data structures that support providing security services such as managing secure and trusted access to information and data integrity on an ad-hoc and/or as needed basis.

### SUMMARY OF THE INVENTION

Briefly stated, the present invention involves a single use secure token appliance that facilitates the trusted exchange of data over networks, including open networks such as the Internet. A singe use secure token appliance includes a secure network interface for receiving token inquiries from system users and responding with authentication and authorization responses. A random number generator or other source of pre-generated random numbers provides a pool of random numbers. A tokenizing component removes selected portions of the random numbers from the pool and packaging the selected portions into a portable form that can be used as needed for authentication, authorization and encryption.

Advantages of the present invention include enabling users to access information securely on an as-needed basis economically and easily. Powerful transient and persistent encryption is available to all users including frequent, infrequent, and one-time users of the secure token appliance. In a way, any entity possessing a valid token is made able to use the secure and trusted data exchange system in accordance with the present invention to the extent authorized by that token. The present invention allows even a casual Internet user to secure data easily without needing to obtain certificates, without special-purpose client software, without managing usernames and passwords. The present invention implements the use of public and private keys in a manner that is transparent to the users.

### BRIEF DESCRIPTION OF THE DRAWINGS

The sole FIGURE shows a system incorporating the present invention and activities performed in the implementation of the present invention.

### DETAILED DESCRIPTION

The present invention involves instant access tokens that are short-lived authentication credentials that provide unique flexibility that is not available with the traditional username/password credential. Using instant access tokens eliminates the need to have visitors interact with the busy technology staff to have a temporary account created that must be deleted later.

The present invention is described in terms of a specific implementation in which single-use tokens are bought and sold or otherwise distributed to users who wish to share data securely. The users include senders (i.e., information owners, holders, and/or uploaders) and recipients (i.e., information receivers or downloaders). However, the present invention is readily extended to support data exchange between software entities, databases, and the like in addition to human users. Moreover, the present invention is described in terms of data exchanged over public networks, however, the present invention is readily adapted for exchange over private, secure networks and hybrid networks including both secure and open components.

Advantageous features of the present invention include:

Ready, Global Access—

Because the present invention enables services that can be provided from any computer (e.g., workstation, PC, laptop, personal digital assistant (PDA) or cell phone) using any of the readily available browsers, it can be accessed ubiquitously to provide security services on-demand.

Transient And Persistent Encryption—

Payload can be encrypted at all times while moving from user to user (i.e., transient protection) as well as being encrypted while information is stored or at rest (i.e., persistent encryption).

Trusted Tokens—

In a particular implementation 12-character tokens generated in accordance with Federal Information Processing Standard FIPS 140-1 L3, ensuring statistical randomness. Various size tokens can be used to meet the needs of a particular application.

Flexibility—

Payload data can be of any standard MIME format including but not limited to images, text, video and audio. In essence, the present invention is agnostic with respect to data format and so can be used to handle data of public formats that are now know or are derived in the future, as well as proprietary or special purpose formats.

High Availability—

Implementations of the present invention exhibit around-the-clock (24×7) availability anywhere in the world, subject to local regulations and restrictions.

Security Features—

The present invention provides trusted performance based on OpenBSD, OpenPGP, OpenSSL and/or hardware RNG.

Format—

The present invention supports a variety of token types including public “retail” tokens and private-label tokens.

Administrative Choice—

Allows the owner of the single use secure token appliance to establish file size, storage duration and access limits to meet the needs of a particular application.

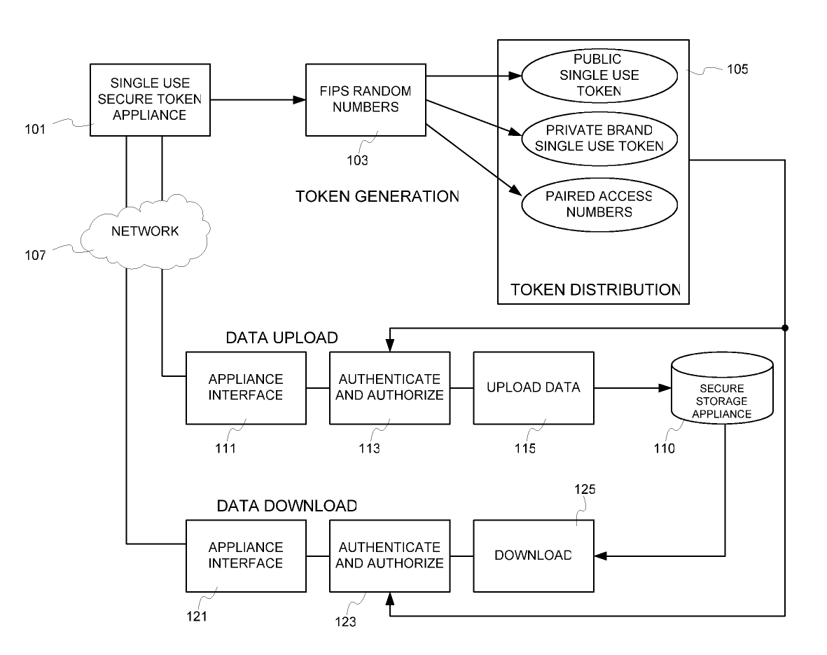

In FIG. 1, single use secure token appliance 101 implements processes for secure data exchange in accordance with the present invention. In particular embodiments secure storage appliance 110 is integrated with the single use secure token appliance 101, although it may be provided as a separate service as well. Appliance 101 implements a number of network connections such as secure socket layer (SSL) connections to network 101.

The single use secure token appliance 101 provides users with an ad hoc trusted and secure network presence. Two important forces are combined for a single temporary use: (1) the compelling technology and availability of the Internet and (2) the strongest encryption commercially available. This strong encryption is supported by a hardware random number generator 103 that ensures a source of strong entropy (FIPS 140-1 Level 3) creating true statistical randomness.

Tokens 105 comprise a set of random numbers that are packaged in, for example a software wrapper, and/or a data structure such as an XML document or the like. Tokens may be distributed in electronic form, or recorded onto a physical media such as a magnetic stripe card, smart card, magnetic disk, USB memory key, or other recording media, as well as stored on a computing device such as a personal digital assistant, personal computer, or the like. In some cases a token may be distributed verbally, visually (e.g., by a screen display), or on paper.

Several varieties of tokens 105 are contemplated. A public, single use token may be distributed at a retail level in any quantity. These tokens may be sold at a predetermined price and may have quantity discounts, or discounts for being bundled with other products/services. For example, tokens may be sold at computer stores, copy centers, packaging and mailing stores, general merchandise stores, automated teller machines, vending machines, and the like. Alternatively, private brand tokens may be distributed through commercial channels. For example, an online retailer may purchase bulk quantities of tokens where the tokens are expended over a number of separate data transfer transactions. In yet another alternative, tokens may be distributed at an enterprise level to, for example, employees of an organization in which they are charged on a per-use basis or charged at a periodic subscription rate for use of the appliance 101.

Tokens 105 provide capabilities that are not found in other systems. Tokens have four properties: duration, intersession, expiration and shelf life. Session Duration refers to the maximum amount of time, in seconds, that a user of a specific token will be able to access the network for a continuous period of time. Inter-session Duration refers to an amount of time, in seconds, that a user of a token has to wait after the current login session expires before he/she can re-login using the same token and begin a new session. Token Expiration refers to an amount of time, in seconds, that a token will remain active after the first time it is used to login. After this duration has expired, the token can never be used again.

Tokens 105 may be generated on demand or in advance. Tokens 105 may be generated one at a time, or in bulk. When generated, a token 105 may be embodied in a variety of forms including as an electronic file in a memory device, or may be embodied on other physical media. Particularly when tokens 105 are generated in advance of use and stored on physical media, it may be useful to obscure the access code to deter copying. In the case of printed media, sealing the code so that it is hidden in an envelope or the like, akin to the manner in which financial records such as checks, tax documents, and the like are protected from visual inspection. Alternatively, the code portion of a token 105 may be covered with a scratch-off material such as commonly used for lottery tickets and the like. Any method that obscures the access code and/or indicates that the physical media in which the code is embodied has been tampered with is suitable. In electronic media the token may be protected by password, or other available data protection such as software that indicates to a user time and date of when the code portion has been accessed.

The following table shows an exemplary set of information that describes two tokens:

| ID or Access Code | Duration | Intersession | Expiration | Shelf Life |
|---|---|---|---|---|
| FxIP a7a6 RZvc | 7200 | 0 | 7200 | Forever |
| FNkJ VYNX DBEG | 3600 | 0 | 7200 | 86400 |

An administrator generates tokens 105 that grant basic access for a specified amount of time by setting the duration and expiration to be the same value. If the expiration is longer than the duration, then the token 105 can be reused any number of times until it expires. Furthermore, the intersession can be set to deny users continuous access. The shelf life is used to completely remove tokens after a specified amount of time. This is useful, for example to a service provider that wishes to sell prepaid Internet access that behaves similarly to prepaid cell phones that must be used by a certain expiration date.

Significantly, tokens 105 comprise a true random sequence and may be configured to be useable for a specific number of times, including being useable only one time. This combination relates generally to the “one time pad” cryptography technique and is a theoretically unbreakable form of security. Users obtain tokens as needed or in advance of a data transfer transaction and the token is consumed when it is used during the transaction. Because the same token will never be used to access or subsequent data, data security cannot be compromised as is possible with other cryptography techniques. Tokens 105 may vary in length with longer tokens 105 being generally more difficult to break, and there may be incremental charges for longer strings of random numbers within a purchased token.

The instant access token implementation in accordance with the present invention is uniquely trustworthy when compared with other single use code authentication systems. In a particular implementation, a token contains a string of random characters of where each character of an instant access token is generated by reading a 8 bit number from a FIPS-140-1 certified hardware random number generator. The lower six bits are then mapped to one of 61 symbols in the alphabet of English alphanumerics without the capital ‘O’ or the lower case “I” to determine that character. This process is repeated to select all of the characters for a particular token.

In a particular implementation, twelve of these randomly picked symbols are concatenated to form an “access code” that is embodied in a token 105. The access code forms a secure and unique identification or signature for the token. The access code may be shared with the authorization/authentication systems 113/123 while the remaining randomly selected characters of a token remain available only within the token itself. The access code may be associated with selected metadata to indicate restrictions or other properties of the associated token 105 such as duration, intersession, expiration, and shelf life described in this document.

Hence, the remaining characters can be used to secure (e.g., encrypt) information in a manner that cannot be compromised even by the mechanisms of the secure data storage system 110 and authorization/authentication systems 113/123.

This methodology yields access token codes that each have approximately 70 bits of true entropy. Since the keys are generated from true hardware entropy, it would be useless to attempt a dictionary attack against the access token system. Moreover, the use of a hardware random generator prevents an attacker from gathering a large number of valid tokens to reverse engineer the cryptographic seed and pseudo-random number generator algorithm in order to predict what other or future codes might be. Finally, direct brute force attack would be a fruitless endeavour because of the bit-strength of the random code.

In operation, a data upload involves using an access appliance 111 (e.g., a web browser, FTP client, or other network service interface) to access appliance 101. The user can be authenticated and authorized using component 113 to upload data via component 115 based upon possession of a token.

Random shared single-use tokens can be distributed such that both the sender (e.g., uploader) and the receiver (e.g., downloader) of a piece of digital information possess the same token and the network address of a secure storage implementation through an appropriate appliance interface 111/121 (e.g., via a domain name). For example, the information sender launches a standard web browser and directs the browser to request secure (i.e., HTTPS) web pages from the network address or domain name of the secure storage implementation. The secure storage implementation responds with a web page that allows the sender to enter the random shared single-use token and the data to be stored (e.g., a file, multiple files, data stream, and the like). The sender populates these fields in their web browser and submits the upload request to the appliance interface 111. The authentication/authorization component 113 checks the random shared single-use token 105 against a list of valid available tokens that is maintained by the secure storage implementation.

If the token 105 is invalid according to administrator defined policy (i.e., the token does not exist, has expired, has exceeded usage maximums, etc.) the request is rejected. Otherwise the payload is then inspected for compliance with administrator defined rules (e.g., maximum file size, maximum number of files, etc.). If the payload does not comply, the request is rejected and the sender notified. If both the random shared single-use token and the payload pass all tests, the implementation encrypts the payload and saves the result to persistent storage provided by secure storage device 110.

To retrieve data, the information receiver launches a standard web browser and connects to the network address of a secure storage implementation as indicated by the appliance interface 121, for example. The secure storage implementation responds with a page that contains a field that allows the information receiver to enter a random shared single-use token 105. The information receiver enters a random shared single-use token 105 into the field and transmits the request to the secure storage implementation. The authentication and authorization component 123, which may be identical to component 113, of the secure storage implementation validates the token and when it is valid, responds with a list of one or more available files or data streams in the secure storage appliance 110 for download that are associated with the entered token 105. When the user clicks on a file using their web browser, the download component 125 decrypts the file using the random shared single-use token 105 (passed in the URL used to download the file) and transmits the result to the information receiver's web browser. In the event that the token 105 is invalid, the appliance interface 121 responds with an error message.

In particular implementations, a data file to be transferred is encrypted using the token 105 and uploaded to storage device 110. Because the data is encrypted before transmission the data is protected during transmission. Neither the authorization component 113 or the secure data storage device 110 need to have knowledge of the keying information used to encrypt the data as they only need to be aware that the user possesses a token. Preferably, the data is persistently encrypted while stored in storage device 110. The data can be stored in a manner that it retains an association with the token 105 used to access secure data storage device so that the data can be retrieved when the same token is presented.

The present invention contemplates that a given token 105 may be associated with a single file and allow both upload and download of that file using the same token. It is also contemplated that a token may be associated with a group of files or a digital stream and allow upload and/or download of that group of files or digital stream. Similarly, a token may be associated with a specified quantity of digital data and allow upload/download access for that specified quantity. Alternatively, a pair of access codes may be associated with a particular file, group of files, or digital stream where one of the pair allows upload and another of the pair allows download. Likewise, the tokens 105 may be configured to enable a one-to-many relationship in which, for example, one token 105 is enabled to upload a file, group of files, digital stream and the like and any number of tokens 105 may be enabled to download that uploaded information. These permissions are readily established when a token 105 is created.

In one implementation the type of file, files, or streams that can be stored is unrestricted in that it can be any size and may represent text, images, music, programs, or other type of digital sequence. The data that is stored may be clear text or may be encrypted depending on the user's needs and requirements of a particular application. Alternatively, storage device 110 may impose limits on the size of files, the duration of storage, file types, and the like to suit the needs of a specific application. These restrictions can be readily assigned on a token-by-token basis such that tokens can be sold at differential pricing for differential services provided by storage device 110.

During transport, data are protected from eavesdropping by, for example, SSLv3/TLSv1 encryption in particular embodiments. Moreover, users may choose to encrypt data using any available data encryption/protection technology available on the user machine before transport between appliance interfaces 111/113. It is contemplated that the data may be encrypted at the user's machine using keying information (e.g., random sequences) provided in conjunction with a token 105 such that a token 105 includes not only an access code that is known to the authentication/authorization components 113/123, but also a set of random numbers/characters that can remain unknown to the authentication/authorization components 113/123.

While at rest, data are protected by, for example, OpenPGP encryption to prevent unauthorized retrieval and decryption. In addition, a Public Key Infrastructure is integrated to a hardened OpenBSD operating system, yet it is transparent to the user. These features work together to generate a strong cryptographic environment.

Users exchange tokens 105 using any convenient means including exchange of a physical embodiment of the token, verbal instructions, written instructions, and the like. When different tokens 105 are used for upload/download exchange of tokens is not necessary as users may be provided with separate tokens that are paired in the system. A recipient or downloading user accesses appliance 101 using interface 121 and is authenticated and authorized using component 123 to download data using component 125 based upon possession of a token. It should be understood that downloading may involve simply viewing the file as well as saving a copy of the file on the recipient's local system. The encrypted data file is transferred and decrypted by the recipient using the token. Preferably, the data is always encrypted from the point it leaves the sending user to the point it is received and decrypted by the recipient user.

In a specific implementation the single use secure token appliance in accordance with the present invention is provided with 3 Tb of storage capacity, supports 10,000 simultaneous SSL connections, and is capable of generating billions of secure tokens for distribution via a range of media-paper, PC, cell phone. In another alternative, the appliance implementation has 1 Tb of storage capacity supporting up to 2,500 simultaneous SSL connections. The present invention may also be made available on a subscription basis for the public and private-label markets.

The present invention is applicable in any industry in which secure information communication is involved. Exemplary use cases include:

Scenario #1:

A large financial institution provides some or all of its business units with the ability to secure network traffic during occasional or infrequent interactions with customers. The institution is faced with a problem in that the customer requirements would be sufficiently temporary to make it impractical to install private band software on the customer's computer or to enroll the customer as an official user in the financial institution's secure e-mail system.

To solve this problem, a customer-facing personnel could use a range of tokens-physical “coat check” tokens or verbally communicated token data from the on-line generator. In an example embodiment, each business unit establishes a time period, for example 45 days, that the data remains available and/or the number of times it could be accessed or other data access restrictions associated with the single use token. The institution then could satisfy the requirements of the Gramm-Leach-Bliley Act even for intermittent or infrequent communication.

Scenario #2:

Physicians, hospitals, insurance companies, and/or other entities charged with keeping medical records are frequently requested to provide those medical records to patients or other entities. The transfer of medical records may involve a single instance in which access to a record storage facility is required. It is not practical with current data access mechanisms to provide this transient access.

In accordance with the present invention, the keeper of these records can handle requests for access to medical records easily and economically and still comply with the stringent requirements of HIPAA. In instances where the physician does not expect an ongoing Internet interaction with the patient—perhaps an orthopaedic surgeon who does not have recurring patients—a patient's HIPAA request could be met by placing the records in the single use secure storage device 110. Alternatively, physicians could annually post all electronic patient records to be viewed and retrieved by their patients, after sending notices and instructions by mail. In either case, physicians could contract for this service through their respective state association, specialty association or the Independent Physicians Association (IPA), which has a business relationship with an owner of an appliance 101. Alternatively, the physician could purchase unbranded public tokens and distributed tokens to clients using any convenient mechanism.

Scenario #3:

Any Internet user who desires to secure information of personal importance—a business plan, a potential patent design, the draft of a novel, a prize-winning recipe—may obtain and use a token to secure the data as it travels over the Internet and while it is stored in the single use secure token appliance 101. The data can be retrieved by the user, or by any other third party to whom the user provides the single use token.

Scenario #4:

In a corporate enterprise, a wireless access point is provided for use by both employees and guests. Typically, wireless network requests are initially redirected to a captive portal where employees enter a username/password credential that is validated by a domain controller such as a Microsoft Windows® 2003 domain controller.

In accordance with the present invention, the login page is augmented to provide space to enter an instant access token so that visiting guests may obtain WLAN access. Often, guests must check in at the front desk where a label printer is used to print temporary badges. The front desk personnel are granted rights to generate instant access tokens. On the badge is a one time use code that is valid for the same duration as the badge itself. The front desk staff record the instant access token along with the visitor's information in the visitor database so that the IT staff can identify the network user should a problem arise.

Scenario #5:

At a hotel, a wireless access point is deployed to authenticate and bill for wireless (lobby) and wireline (in-room) access to the Internet. Network requests are initially redirected to a captive portal where hotel guests who have accounts with roaming partners (i.e., Boingo, GRIC, T-mobile, . . . ) can enter a username/password credential. In accordance with the present invention, the login page also includes a space to enter an instant access token so that guests who do not have an established account with a wireless service aggregator can buy access rights directly from the hotel. Back-office personnel, for example, are granted restricted administrative rights to the access point so that they can generate instant access tokens. For example, once a week, a back-office administrative assistant generates a batch of instant access tokens and prints/saves them. Front desk personnel can offer Internet access to guests when they check-in. If a guest desires access, a charge is made to the room account.

It can be appreciated that the present invention is a compelling alternative to traditional username/password credentials. Both enterprises and service providers can benefit by using instant access tokens. Support for multiple parameters allows the network administrator to customize the experience of each type of token as well as meet the needs of unique customers. Finally, various implementations of the present invention also raise the bar in trustworthiness by incorporating a hardware random number generator and 70-bit strong codes.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

1. A single use secure token comprising: a consumable random sequence that is accessible by an appliance to authenticate and authorize a holder of the token and to cryptologically protect data files.

2. The single use secure token of claim 1 wherein the consumable random sequence is packaged in a software wrapper.

3. The single use secure token of claim 1 wherein the consumable random sequence is packaged in an extensible markup language (XML) document.

4. The single use secure token of claim 1 wherein the consumable random sequence is distributed electronically.

5. The single use secure token of claim 1 wherein the consumable random sequence is stored in a physical media.

6. The single use secure token of claim 5 wherein the physical media is selected from the group consisting of: a magnetic stripe card, smartcard, magnetic disk, read only memory, read-write memory, and USB key.

7. The single use secure token of claim 1 wherein the consumable random sequence is generated by a hardware random number generator that provides strong entropy of Federal Information Processing Standards (FIPS) 140-1 Level 3 or greater.

8. A single use secure token appliance comprising: a secure network interface for receiving token inquiries from system users and responding with authentication and authorization responses; a random number generator for generating a pool of random numbers; a tokenizing component for removing selected portions of the random numbers from the pool and packaging the selected portions into a portable form that can be used as needed for authentication, authorization and encryption.

9. The single use secure token appliance of claim 8 wherein the random number generator provides strong entropy Federal Information Processing Standards (FIPS) 140-1 Level 3 or greater.

10. The single use secure token appliance of claim 8 wherein the tokenizing component packages the selected portions inside a software wrapper.

11. The single use secure token appliance of claim 8 wherein the tokenizing component packages the selected portions inside an XML wrapper.

12. The single use secure token appliance of claim 8 wherein the tokenizing component packages the selected portions as 12-character tokens in compliance with Federal Information Processing Standards (FIPS) 140-1 L3.

13. The single use secure token appliance of claim 8 wherein the portable form comprises non-volatile memory.

14. The single use secure token appliance of claim 8 wherein the portable form comprises a volatile memory.

15. A system for secure data communication comprising:
a single use secure token appliance operable to generate single use secure tokens;
a token distribution component operable to distribute the single use secure tokens to users;
a data storage component; and
an access appliance controlling access to the data store by authenticating a user based upon possession of a singe use secure token.

16. The system of claim 15 wherein the access appliance comprises a physical computer coupled to the data storage component.

17. The system of claim 15 wherein the access appliance comprises a network attached computer having an interface for communicating with a user possessing a single use token over a network.

18. The system of claim 15 wherein the data storage component stores data encrypted by the single use secure token.

19. The system of claim 15 wherein the data storage component does not include cryptographic mechanisms operable to decrypt data stored therein when that data is encrypted with a single use token.

20. The system of claim 15 wherein the data storage component stores data irrespective of data format.

21. A method of secure data handling comprising:
obtaining a single use secure token comprising a consumable random sequence;
accessing a data store through a data store access mechanism, wherein the data store access mechanism authorizes access to the data store based upon possession of the single use secure token;
encrypting selected data using the consumable random sequence of the single use secure token; and
transmitting the encrypted data to the data store after authentication by the data store access mechanism.

22. The method of secure data handling of claim 21 wherein the data store access mechanism is unaware of the user identity.

23. The method of secure data handling of claim 21 further comprising:
accessing the data store through the data store access mechanism, wherein the data store access mechanism authorizes access to the data store based upon possession of the single use secure token;
requesting encrypted data stored in the data store that is associated with the possessed single use secure token;
transmitting the requested encrypted data from the data store to the user in possession of the single use secure token after authentication by the data store access mechanism; and
decrypting the requested encrypted data using the consumable random sequence of the single use secure token.

24. The method of secure data handling of claim 23 wherein a first user transmits the encrypted data to the data store and a second user that is different from the first user requests the encrypted data from the data store, wherein the first user and the second user exchange the secure single use token.
